(19) United States
(12) Patent Application Publication
(10) Pub. No.: US 2010/0258534 A1
(43) Pub. Date: Oct. 14, 2010

(54) METHOD OF CONVERTING A GAS TUNGSTEN ARC WELDING SYSTEM TO A PLASMA WELDING SYSTEM

(76) Inventor: Russell Vernon Hughes, Plymouth, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/756,540

(22) Filed: Apr. 8, 2010

Related U.S. Application Data
(60) Provisional application No. 61/167,630, filed on Apr. 8, 2009.

(51) Int. Cl. B23K 9/16; B23K 10/00

(52) U.S. Cl. 219/75; 219/121.5

(57) ABSTRACT

A welding system includes a gas tungsten arc welding power source having a welding arc contactor, a plasma welding torch, and a gas console that supplies gases to the plasma welding torch. The welding system also includes a coolant flow switch connected in series with the welding arc contactor. Power is not provided from the gas tungsten arc welding power source to the plasma welding torch when the coolant flow switch is not actuated.

### REFERENCE TO RELATED APPLICATION

This application claims priority to U.S. Provisional Application No. 61/167,630 filed Apr. 8, 2009.

### BACKGROUND OF THE INVENTION

The present invention relates generally to a method of converting a gas tungsten arc welding (GTAW) system to a plasma welding system.

Plasma welding equipment is more expensive than gas tungsten arc welding equipment, at least partially due to the additional cost of a plasma welding control console. A plasma welding torch is more internally complex than a gas tungsten arc welding torch as it incorporates design features commensurate with operation of a pilot arc. Manual plasma welding is relatively uncommon in the industrial workplace, although it provides the advantages of deeper weld penetration, a more focused welding arc, and reduced operator dexterity requirements compared to gas tungsten arc welding. Plasma welding can also be used to weld aluminum and magnesium, as can gas tungsten arc welding.

FIG. 1 illustrates a typical plasma welding system 20 including a DC welding power supply 22 connected to a primary power source 18, a coolant recirculator 24, a plasma welding control console 26, a plasma welding torch 28, a supply of shield gas 30, and a supply of plasma gas 32. The welding power supply 22 is generally a constant current power supply. The coolant recirculator 24 should have a thermal capacity adequate to properly cool the plasma welding torch 28. The plasma welding control console 26 generates a pilot arc for welding arc ignition that is maintained in operation at the plasma welding torch 28. The plasma welding control console 26 also directs and controls the flow of plasma gas 32 and shield gas 30 to the plasma welding torch 28 and directs the coolant supplied from the coolant recirculator 24 to and from the plasma welding torch 28.

Hoses 40 and 42 direct the shield gas 30 and the plasma gas 32, respectively, to the plasma welding control console 26. A work cable 49 provides power from the welding power supply 22 to a workpiece 50 to be welded. A power supply control cable 44 provides power from the welding power supply 22 to the plasma welding control console 26. The plasma welding control console 26 (further shown in FIG. 2) acts as a “mixing box,” directing the coolant, gas(es) and welding current to the plasma welding torch 28 through a cable and hose umbilical 45.

A weld sequencer 34 and a remote pendant control 36 can be employed for controlling the welding current. Alternatively, a remote foot switch 38 can be utilized to control the welding current, especially during manual operation.

As shown in FIGS. 3A, 3B and 3C, the plasma welding torch 28 can be arranged with a non-consumable tungsten electrode 54 and a constricting nozzle 52 (often referred to as the “tip”) in a multiplicity of geometric configurations. Each of these configurations produces unique and different arc characteristics that can range from “soft” or shallow penetrating arcs to “hard” or deeply penetrating arcs. FIG. 3A shows the electrode 43 set back relative to the nozzle 52, FIG. 3B shows the electrode 43 flush relative to the nozzle 52, and FIG. 3C shows the electrode 43 set forward relative to the nozzle 52.

FIG. 4 shows a schematic of a conventional plasma welding control console 26 that incorporates a gas pressure interlock 56 and a coolant pressure interlock 57. The coolant pressure interlock 57 is important because the plasma welding torch 28 operates at very high temperatures (10,000 to 25,000° C.), and uninterrupted flow of adequate coolant to the plasma welding torch 28 is essential to prevent failure. Interruption or failure of the gas flow(s) is generally less damaging to the plasma welding torch 28 and usually requires replacement of the electrode 54 and the nozzle 52.

A typical 200 ampere capacity gas tungsten arc welding system includes a coolant recirculator, a gas tungsten arc welding (GTAW) welding torch, and a remote foot switch. Alternating current welding can be used to weld aluminum and magnesium alloys. It is expensive to convert a gas tungsten arc welding system to a plasma welding system as the plasma welding control console 26 must be purchased.

In plasma welding, a pilot arc is typically required for welding arc (main arc) ignition because the recessed electrode 54 can cause “double-arcing” if gas tungsten arc welding methods of arc ignition, such as high-frequency (HF) discharge, are used. During “double-arcing,” the welding arc routes from the electrode 54 to the nozzle 52 to the workpiece 50 instead of directly from the electrode 54 to the workpiece 50, which could potentially damage the nozzle 52 in the process.

The nozzles 52 shown in FIGS. 3A and 3B are generally immune to this type of damage when using high-frequency as a welding arc ignition method. With the technique, commonly known as “Lift-TIG,” the welding arc is ignited at a very low current by touching the point of the electrode 54 to the workpiece 50, and the operator lifts the plasma welding torch 28 to draw the welding arc. In the projected electrode 54 configuration shown in FIG. 3C, the electrode 54 is set forward or advanced of the nozzle 52. High-frequency arc starting is therefore not a necessity for welding arc ignition with the arrangement shown in FIG. 3C.

The use of a pilot arc can be disadvantageous, particularly in the case of manual welding. The pilot arc is extremely hot (as much as 10,000° C.) and can be a source of ignition to material in the welding locale, requiring care.

One prior plasma torch nozzle includes additional ports drilled concentrically around a main central orifice that provide additional focusing and concentration of a welding arc by diverting or apportioning some of the plasma gas that would normally vent solely through the main central orifice through these ports. The ports and the main central orifice are usually located on the same surface of the plasma torch nozzle. A plasma arc generated by the main central orifice is focused by the surrounding drilled holes, through which some of the plasma gas fed into the welding torch is “bled” off. The “bleed” gas helps to focus the plasma arc.

Depending on the amount of gas supplied to the plasma torch nozzle, the focusing of the welding arc can be varied. In some cases, sufficient gas can be used to focus the weld arc and a “shielding gas” is unnecessary. If a shield cup is not employed, provided the plasma and focusing gas is adequate, the welding torch nozzle can be used to access joint configurations that could not otherwise be accommodated. Eliminating the need for a shielding gas can also simplify the design of the welding torch and the equipment associated with use of the process.

Plasma torch nozzles can be made from copper as it exhibits good thermal and electrical conductivities. In one example, copper with a very low oxygen content (commonly referred to as oxygen free copper) can be used. Copper can be difficult to machine, and it can be difficult to drill small holes in this material.

### SUMMARY OF THE INVENTION

A welding system includes a gas tungsten arc welding power source having a welding arc contactor, a plasma welding torch, and a gas console that supplies gases to the plasma welding torch. The welding system also includes a coolant flow switch connected in series with the welding arc contactor. Power is not provided from the gas tungsten arc welding power source to the plasma welding torch when the coolant flow switch is not actuated.

In one exemplary embodiment, a plasma torch nozzle assembly includes a torch body, an insulator located inside the torch body, and an electrode. The insulator includes focusing ports or grooves on an external surface of the insulator that focus a shielding gas centrally towards a welding arc.

In one exemplary embodiment, a plasma torch nozzle assembly includes a shield cup to prevent leakage of a shielding gas, a torch body, an insulator located inside the torch body, an electrode, and an annular ring including focusing holes that focus the shielding gas centrally towards a welding arc.

In one exemplary embodiment, a plasma torch nozzle assembly includes a shield cup to prevent leakage of a shielding gas, a torch body, an insulator located inside the torch body, an electrode, and a nozzle. The nozzle includes a surface having a central bore and shield gas holes that surround the central bore through which a shielding gas flows that is focused centrally towards a welding arc.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 illustrates a plasma welding system;

FIG. 2 illustrates a plasma welding control console used in the plasma welding system;

FIG. 3A illustrates a constricting nozzle and a tungsten electrode in a set back position;

FIG. 3B illustrates the constricting nozzle and the tungsten electrode in a flush position;

FIG. 3C illustrates the constricting nozzle and the tungsten electrode in a set forward position;

FIG. 4 illustrates a plasma welding control console;

FIG. 5 shows the system of the present invention;

FIG. 6A illustrates a gas console of the system;

FIG. 6B illustrates the gas console and a mounting bracket;

FIG. 7 illustrates a twin gas supply to a welding torch with plasma gas being proportion by a flow control valve;

FIG. 8 illustrates an alternate gas console with a direct mount feature;

FIG. 9 illustrates an alternate gas console with a single flowmeter;

FIG. 10 illustrates a single gas supply to the welding torch divided by a tee-piece;

FIG. 11A illustrates a side view of welding torch with a side mounted plasma gas diversion/flow control valve;

FIG. 11B illustrates a bottom view of a side welding torch with a top mounted plasma gas diversion/flow control valve;

FIG. 11C illustrates a side view of welding torch with a top mounted plasma gas diversion/flow control valve;

FIG. 11D illustrates a bottom view of a side welding torch with a top mounted plasma gas diversion/flow control valve;

FIG. 11E illustrates a side view of welding torch with a lever valve;

FIG. 11F illustrates a top view of welding torch with a lever valve;

FIG. 12A illustrates a top view of a welding torch with a slider switch;

FIG. 12B illustrates a side view of a welding torch with a slider switch;

FIG. 12C illustrates a top view of a welding torch with a rocker type switch;

FIG. 12D illustrates a side view of a welding torch with a rocker type switch;

FIG. 13 illustrates a coolant flowswitch;

FIG. 14A illustrates a welding torch including an electrode position adjusting screw;

FIG. 14B illustrates a portion of the welding torch including the electrode position adjusting screw;

FIG. 15A illustrates a pre-set electrode design;

FIG. 15B illustrates a sectional view of the pre-set electrode assembly;

FIG. 16A illustrates pre-set electrodes of different lengths differentiated with colored o-rings;

FIG. 16B illustrates pre-set electrodes of different lengths differentiated with marker lines;

FIG. 17A illustrates a cross-sectional view of a plasma arc nozzle;

FIG. 17B illustrates an exploded view of the plasma arc nozzle of FIG. 17A;

FIG. 18A illustrates a cross-sectional view of a plasma arc nozzle;

FIG. 18B illustrates an exploded view of the plasma arc nozzle of FIG. 18A;

FIG. 19A illustrates a cross-sectional view of a plasma arc nozzle;

FIG. 19B illustrates an exploded view of the plasma arc nozzle of FIG. 19A;

FIG. 20A illustrates a cross-sectional view of a plasma arc nozzle;

FIG. 20B illustrates an exploded view of the plasma arc nozzle of FIG. 20A;

FIG. 21A illustrates a cross-sectional view of a plasma arc nozzle;

FIG. 21B illustrates an exploded view of the plasma arc nozzle of FIG. 21A;

FIG. 22A illustrates a cross-sectional view of a plasma arc nozzle;

FIG. 22B illustrates an exploded view of the plasma arc nozzle of FIG. 22A;

FIG. 23A illustrates a cross-sectional view of a plasma arc nozzle;

FIG. 23B illustrates an exploded view of the plasma arc nozzle of FIG. 23A;

FIG. 24A illustrates a cross-sectional view of a plasma arc nozzle; and

FIG. 24B illustrates an exploded view of the plasma arc nozzle of FIG. 24A.

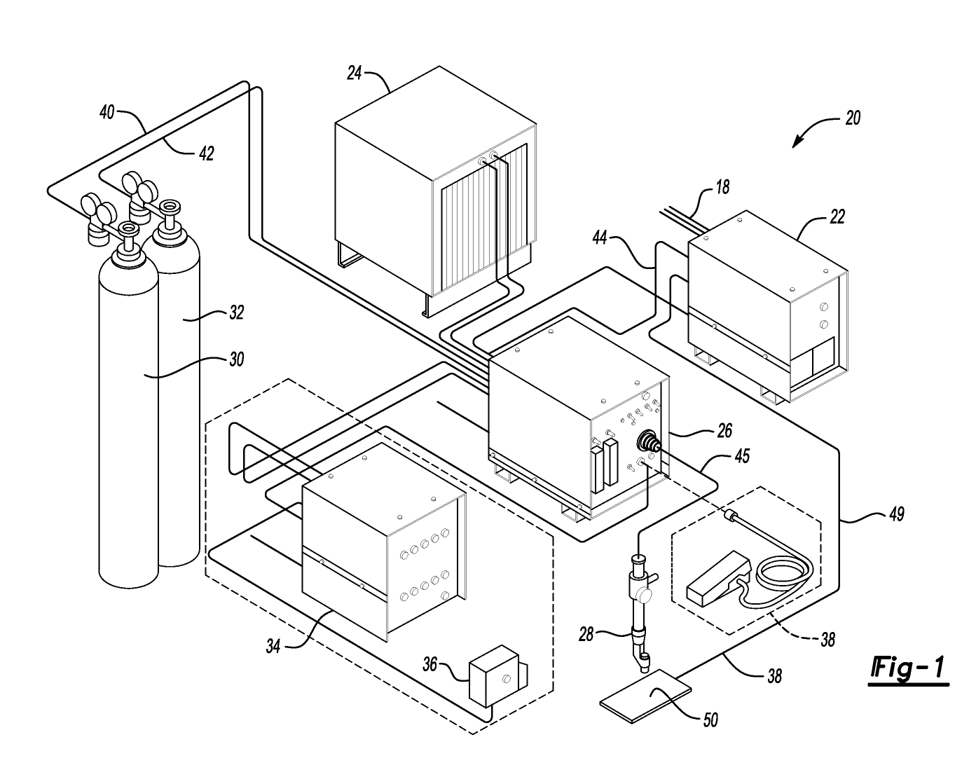

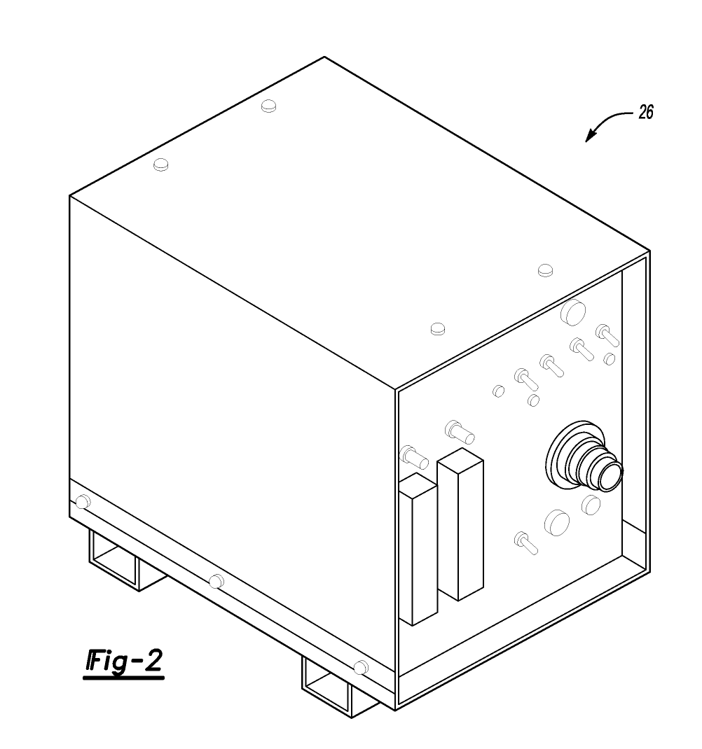

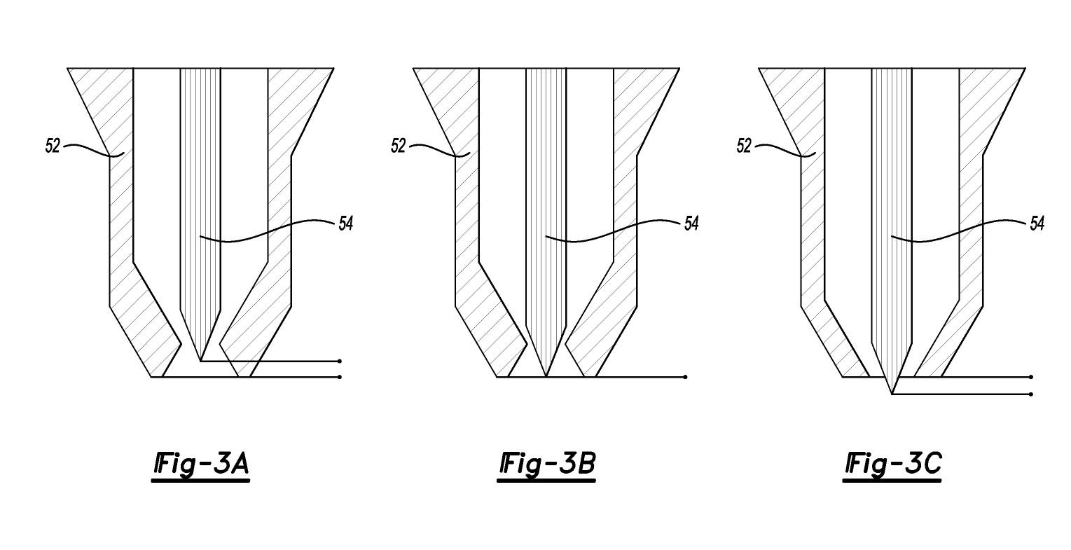

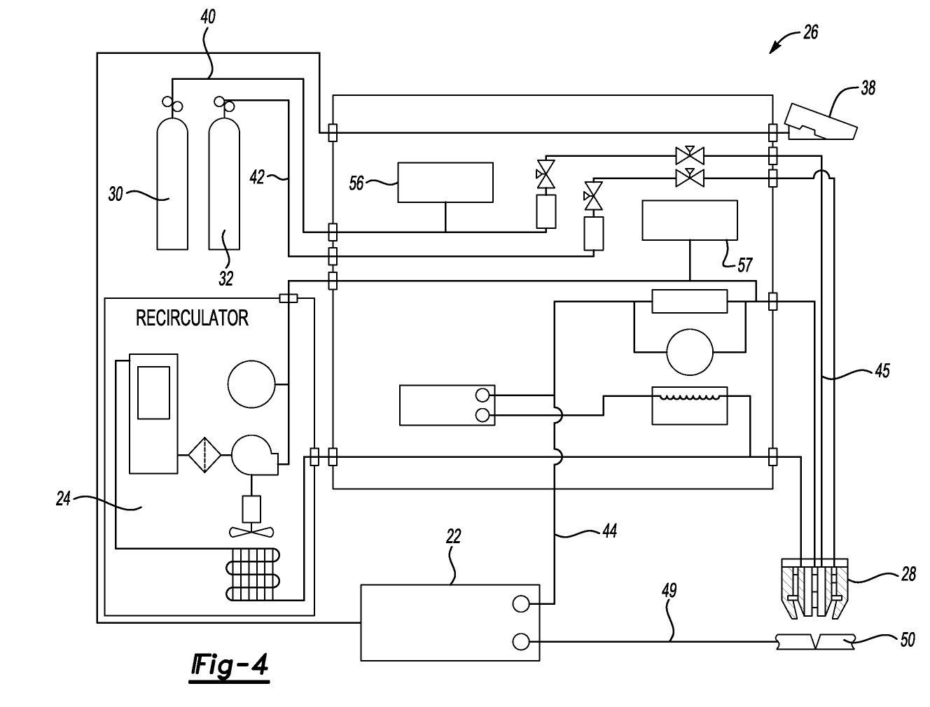

### DETAILED DESCRIPTION OF THE PREFERRED EMBODIMENT

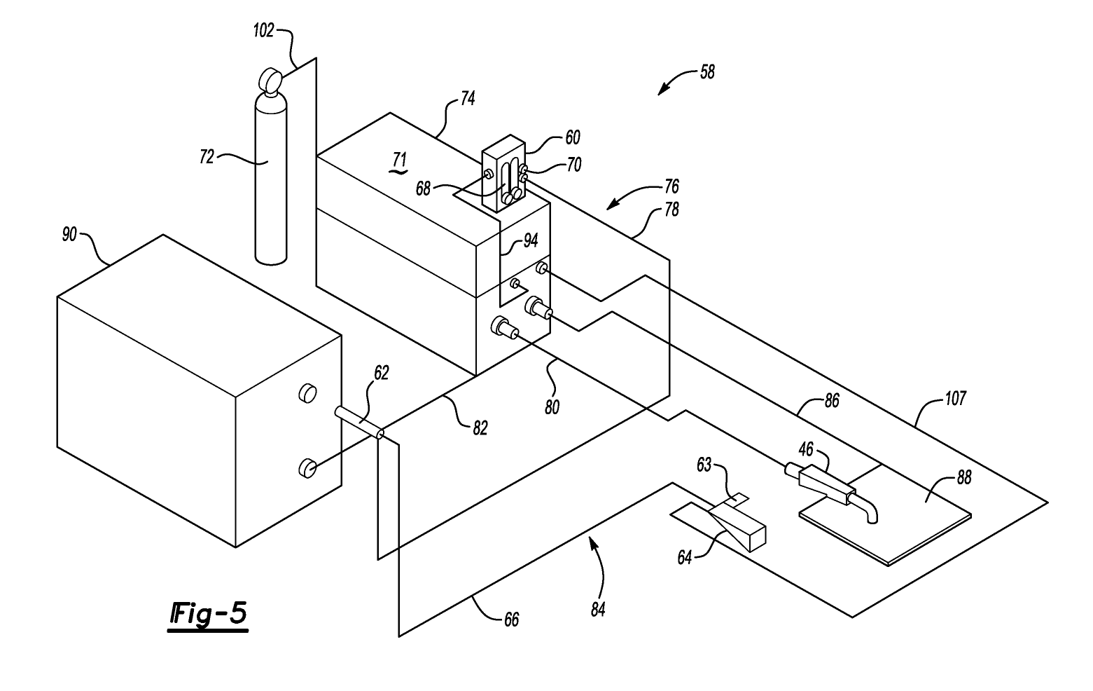

FIG. 5 illustrates the system 58 of the present invention. The system 58 includes a gas console 60 (or a flowmetering “box”) for a plasma gas and a shield gas and a coolant flowswitch 62 connected in series with a remote foot switch pedal 64 (contactor and current control) by a pair of coolant flow switch signal wires 66 connected in series with a power source contactor switch 63 in the remote foot pedal 64 to prevent either accidental or deliberate initiation of a welding arc unless adequate flow of coolant through a plasma welding torch 46 is detected. The gas console 60 includes a plasma gas flowmeter 68 and a shield gas flowmeter 70. A gas tungsten arc welding power source contactor 71 of the gas console 60 functions when an operator presses the remote foot switch pedal 64.

A supply gas is fed from a regulated source, such as a common gas supply bottle 72, and into a gas tungsten arc welding power source 74 through a hose 102. A solenoid valve (not shown) inside the gas tungsten arc welding power/TIG source 74 opens prior to arc ignition, supplying gas from the gas tungsten arc welding power source 74 to the gas console 60 through a connection hose 94. A work cable 86 provides power from the gas tungsten arc welding power source 74 to a workpiece 88 to be welded. A shield gas supply hose 78 and a plasma gas supply hose 76 direct the shield gas and the plasma gas, respectively, from the gas console 60 to the plasma welding torch 46. A power cable 80 provides power from the gas tungsten arc welding power source 74 to the plasma welding torch 46.

A coolant supply hose 82 provides coolant from a coolant recirculator 90 to the gas tungsten arc welding power source 74, and the coolant and power is provided to the plasma welding torch 46 through the power cable 80. Coolant from the plasma welding torch 46 returns to the coolant recirculator 90 through a coolant return hose 84. A cable 107 from the gas tungsten arc welding power source 74 to the remote foot switch pedal 64 provides for contactor closure and current control of the power source by the remote foot switch pedal 64.

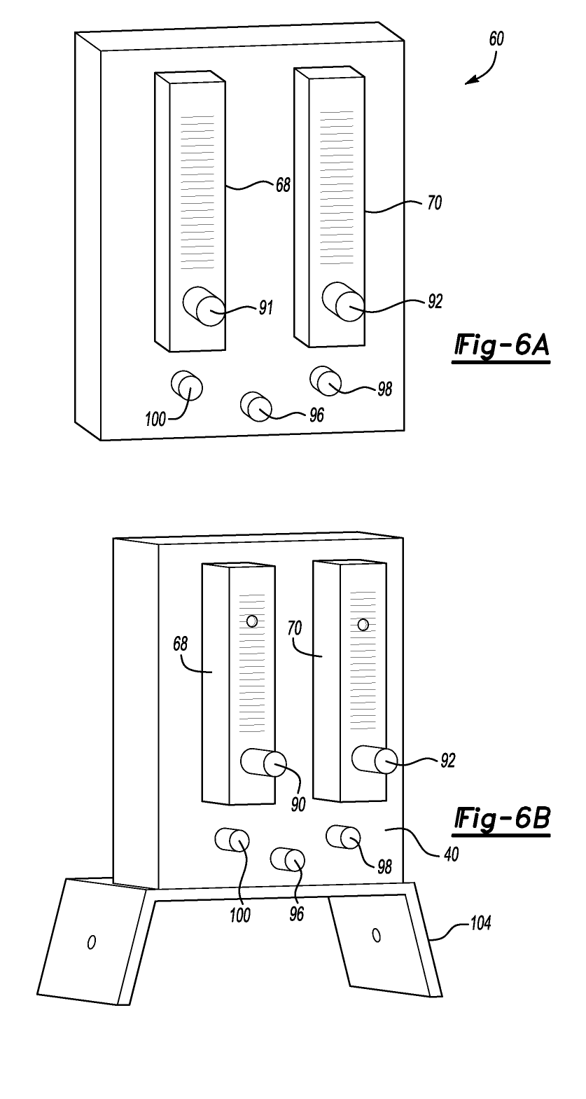

FIG. 6A illustrates the gas console 60 including the plasma gas flowmeter 68 and the shield gas flowmeter 70. The gas console 60 also includes a plasma gas flow control regulator 91 and a shield gas flow control regulator 92. The gas from the gas supply bottle 72 passes through the gas tungsten arc welding power source 74 and the solenoid valve switches such that the gas enters the gas console 60 through a gas supply inlet 96. The plasma gas flows out a plasma gas outlet 100 and along the plasma gas supply hose 76 to the plasma welding torch 46, and the shield gas flows out of a shield gas outlet 98 and along the shield gas supply hose 78 to the plasma welding torch 46. The gas console 60 should be mounted in an upright orientation if conventional flowmeters are to be used. As shown in FIG. 6B, the gas console 60 can be mounted to the gas tungsten arc welding power source 74 (not shown) by a mounting bracket 104.

In prior gas tungsten arc welding processes, the supply gas is supplied directly to a gas tungsten arc welding torch after exiting the solenoid valve inside the gas tungsten arc welding power source 74. In the invention, after the supply gas enters the gas console 60, the supply gas is divided by a “tee piece” (not shown) and directed to the plasma gas flowmeter 68 and the shield gas flowmeter 70. The shield gas and the plasma gas flow to the plasma welding torch 46 through the shield gas supply hose 78 and the plasma gas supply hose 76, respectively.

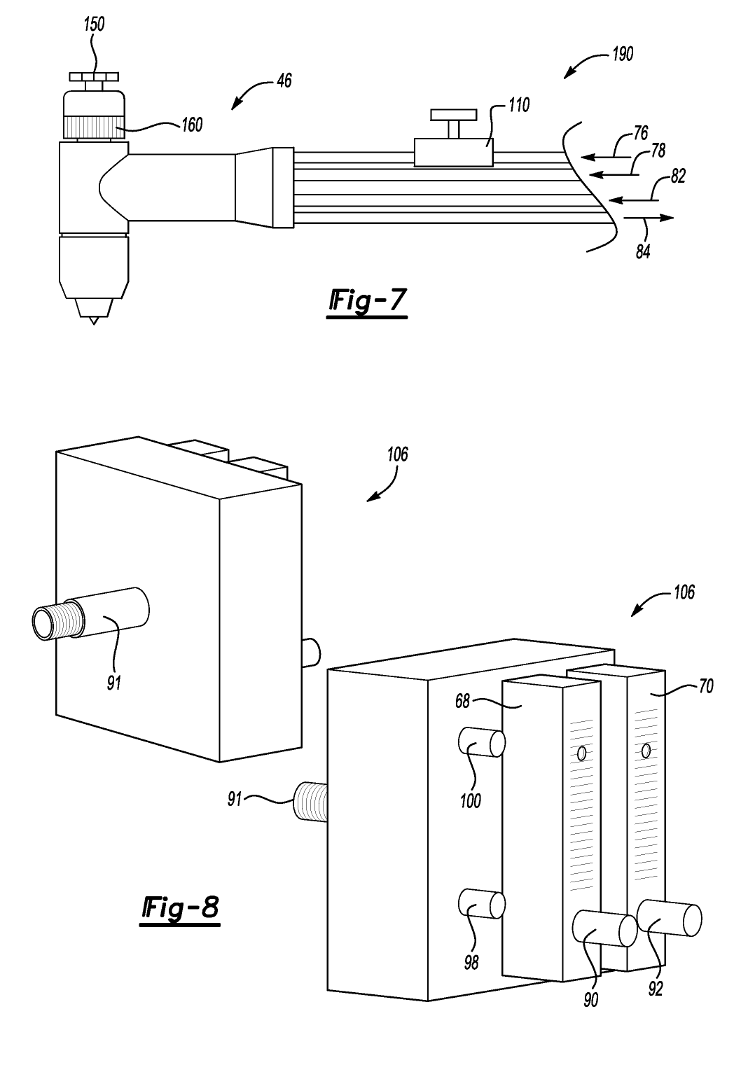

FIG. 7 illustrates a twin gas supply 190 to a welding torch with plasma gas being proportion by a flow control valve 110. The twin gas supply 190 includes four cables that are used with the gas console 60 of FIGS. 6A and 6B. The four hoses are the plasma gas supply hose 76, the shield gas supply hose 78, the coolant power to the coolant supply hose 82, and the coolant power from the coolant return hose 84. The flow control valve 110 is located on the plasma gas supply hose 76. For operators working remotely from the gas tungsten arc welding power source 74 and the gas console 60, the ability to alter the plasma gas flow at the plasma welding torch 46 is useful, even when the gas console 60 with two flowmeters 68 and 70 is used. The plasma gas and the shield gas are supplied down the plasma gas supply hose 76 and the shield gas supply hose 78, respectively, to the plasma welding torch 46, and the plasma gas flow could be adjusted independently of the shield gas flow to change the penetration characteristics of the welding arc without having to make adjustments at the gas console 60. The plasma welding torch 46 also includes an insulated electrode adjustment screw 150 and an electrode clamping knob 160.

FIG. 8 illustrates an alternative gas console 106 including a gas fitting and spacer 91 that attaches the gas console 106 directly to the gas tungsten arc welding power source 74, omitting the need for the connection hose 94. In one example, the gas fitting and spacer 91 are threaded. This configuration is beneficial if there are space restrictions without compromising access to the power source controls, torch connections, etc.

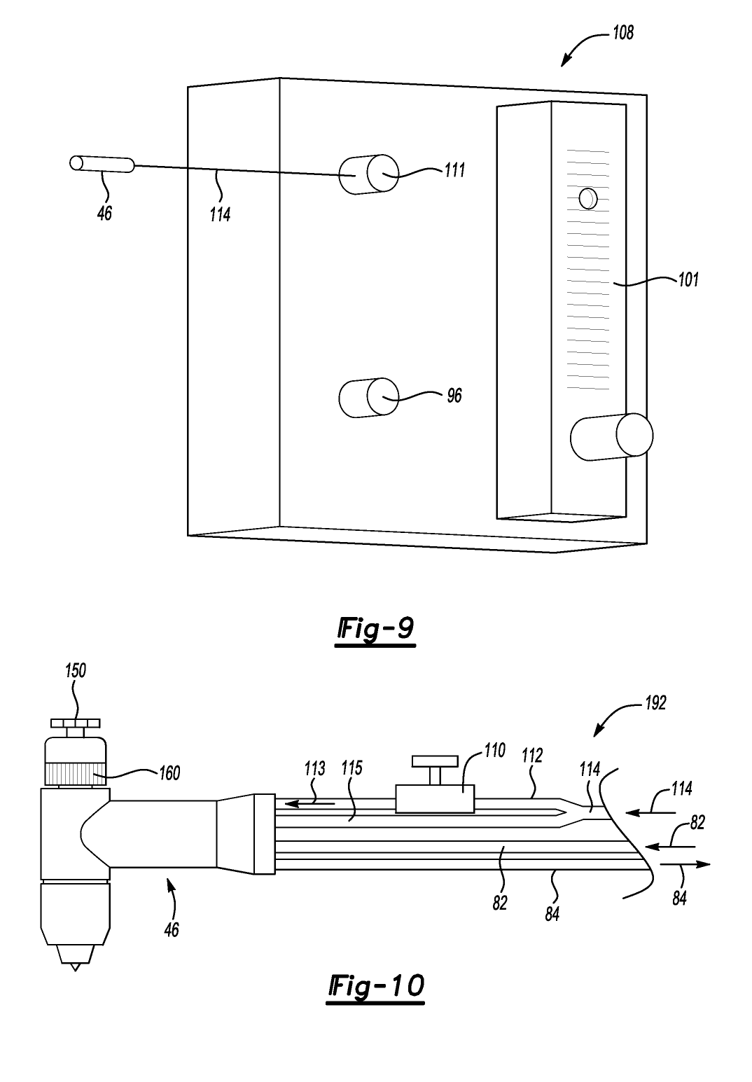

FIG. 9 shows an alternate gas console single gas supply 108 including a single flowmeter 101. Both the plasma gas and the shield gas from the gas supply bottle 72 are directed into the gas tungsten arc welding power source 74. After passing through the gas tungsten arc welding power source 74 (via the internal solenoid valve), the gas is directed into the gas supply inlet 96 of the gas console 108 and flows through the single flowmeter 101 where it is regulated to a flowrate of around 15 liters per minute (LPM). The gas flows from the gas console 60 through a combined gas supply outlet 111 and flows through a single hose 114 to the plasma welding torch 46. In this example, the plasma gas supply hose 76 and the shield gas supply hose 78 are combined into a single hose 114.

FIG. 10 illustrates a single gas supply to the plasma welding torch 46 used with the gas console 108 of FIG. 9. A “tee-piece” 112 divides the gas supply in a hose 114 into a plasma gas flow branch 113 and a shield gas flow branch 115. The plasma gas flow branch 113 includes a flow control valve 110 that proportions the plasma gas flow. The flow control valve 110 does not fully close, and there will always be a small flow of plasma gas through the nozzle 52 of the plasma welding torch 46. Typically, the minimum flow of plasma gas is 1 liter per minute, and 14 liters per minute of flow exit the plasma welding torch 46 as shield gas. The 1 liter per minute flow of plasma gas protects the electrode 54 from oxidation and damage if the operator initiates a welding arc without first checking the flow control valve 110.

If the flow control valve 110 is opened, a greater amount of plasma gas will be gradually apportioned to the nozzle 52, creating an arc with deeper penetrating capabilities over one with a lower plasma gas flow rate. When the flow control valve 110 is fully opened, the plasma gas flow may typically be increased to 5 liters per minute, and very deep penetrating welds can be made. The shield gas flow would be reduced to 10 liters per minute. If more shield gas is necessary, the total flow could be adjusted at the gas console 108.

A coolant supply hose 82 provides coolant from a coolant recirculator 90 to the gas tungsten arc welding power source 74, and the coolant and power is provided to the plasma welding torch 46 through the power cable 80. Coolant from the plasma welding torch 46 returns to the coolant recirculator 90 through a coolant return hose 84. A cable 107 from the gas tungsten arc welding power source 74 to the remote foot switch pedal 64 provides for contactor closure and current control of the power source by the remote foot switch pedal 64.

Incorporating a branch or “tee-piece” 112 and a flow control valve 110 into the torch handle 118 of the plasma welding torch 46 permits the supply of the plasma gas and the shield gas to the plasma welding torch 46 via a single hose 114, which is only divided at the plasma welding torch 46. This reduces the number of service cables to 3 (instead of 4), resulting in a less bulky and more flexible umbilical that improves the ergonomics of the assembly for the operator.

An electrical switch could be fitted to the handle of the plasma welding torch 46 that controls a proportioning valve or mass flow controller mounted within the gas console 60 instead of a needle type valve where high levels of accuracy and repeatability are demanded for metering of the plasma gas. Presently, available plasma welding torches 46 and gas tungsten welding arc welding torches often use a similar type of switch to adjust the level of welding current, overcoming the need for a remote foot switch pedal 64.

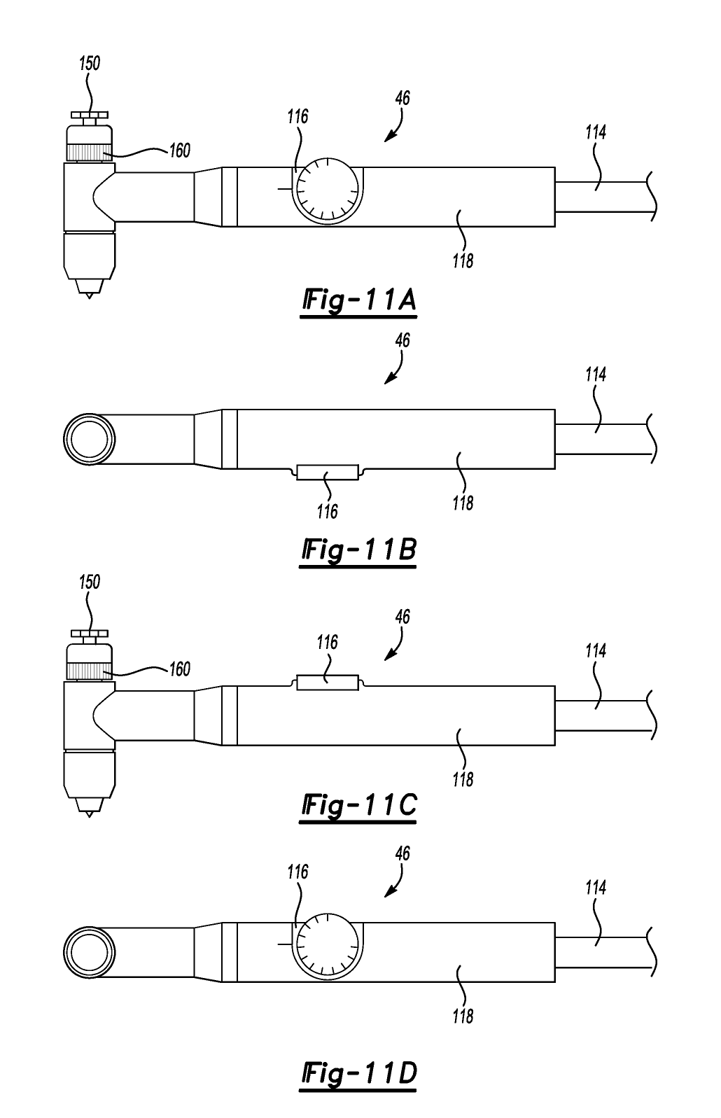

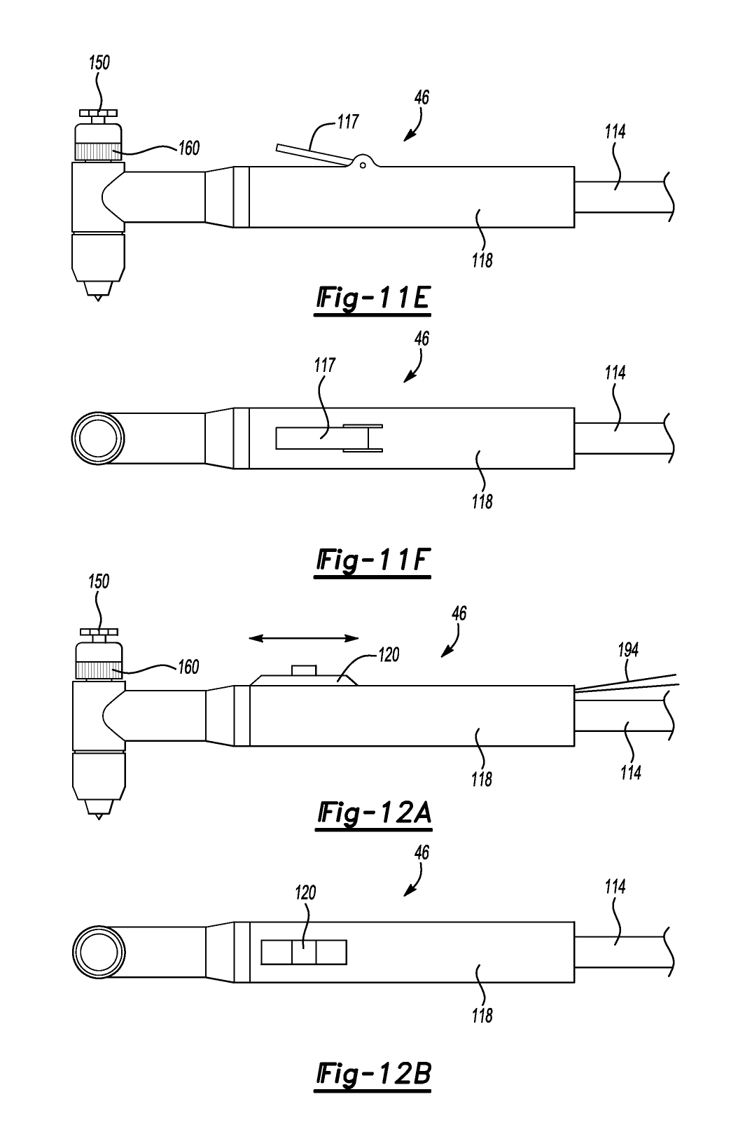

The plasma gas flow control on the plasma welding torch 46 could take several forms. FIGS. 11A and 11B illustrate a side mounted plasma gas diversion/flow control valve incorporated a plasma welding torch 46. A knob 116 on the flow control valve 110 includes a scale that indicates to the user how many liters per minute of plasma gas are being diverted through the nozzle 52. The knob 116 can be side mounted on a torch handle 118 where it easily actuated by the index finger during welding. The knob 116 could also be top mounted (as shown in FIG. 11C or 11D) or include a lever 117 (as shown in FIG. 11E or 11F).

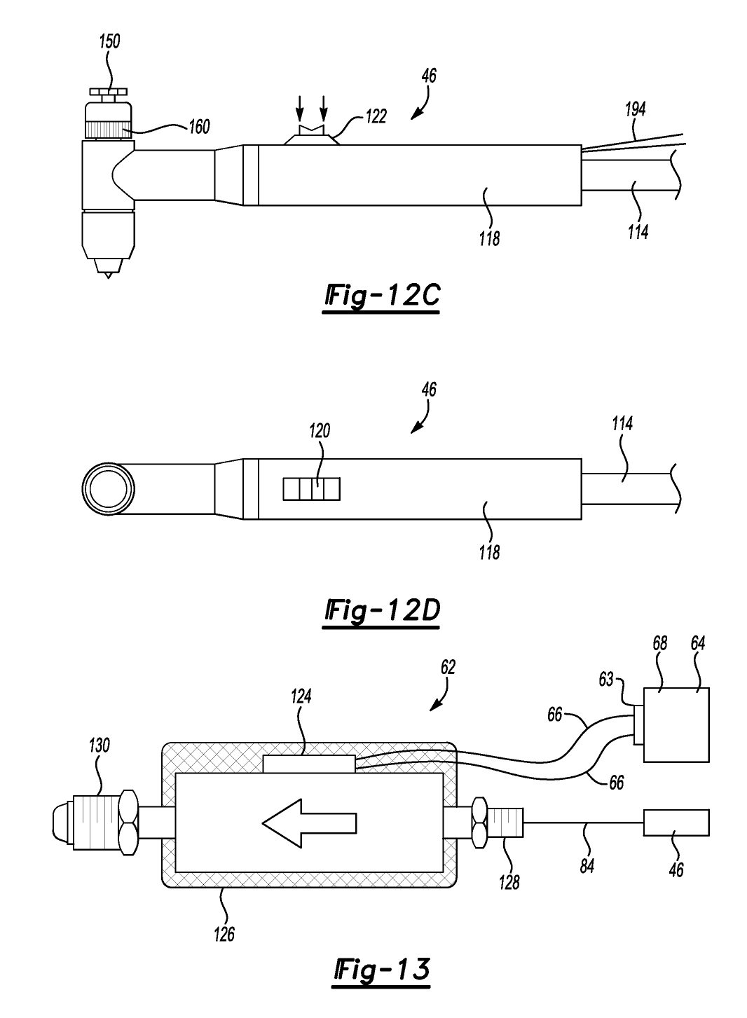

FIGS. 12A and 12B illustrate the plasma welding torch 46 with a slider switch 120, and FIGS. 12C and 12D illustrates the plasma welding torch 46 with an incremental rocker-type switch 122 for affecting remote control of the plasma gas. In FIG. 12A, the slider switch 120 provides an electrical signal to a proportioning valve/mass flow controller. In FIG. 12B, the incremental rocker-type switch 120 incrementally changes a setting of a proportioning valve/mass flow controller. The plasma welding torch 46 could incorporate two switches: one for adjusting plasma gas flow and the other for adjusting welding current. The plasma welding torch 46 also includes control wires 194 for a proportioning valve.

By adding the gas console 60, 106 or 108 and controlling of the amount of plasma gas through the plasma welding torch 46, a gas tungsten arc welding system can operate as a plasma welding system at a lower cost than by adding the expensive welding control console 26 of the prior art. The gas console 60, 106 and 108 has a lower cost than the welding control console 26 of the prior art as a pilot arc is not needed, allowing a gas tungsten welding arc system to operate as a plasma welding system at a lower cost.

In prior welding control consoles, a pressure switch is used to detect the presence of coolant. However, pressure can be generated without flow of coolant if there is a blockage at the coolant return. In the present invention, a coolant flowswitch 62 used in conjunction with a system including a gas console 60, 106 and 108 ensures flow of the coolant through the plasma welding torch 46.

The coolant flowswitch 62 acts as a safeguard to the plasma welding torch 46. If the equipment operator neglects to power up or adequately connect the coolant supply to the plasma welding torch 46 without the intervention of the coolant flowswitch 62, ignition of a welding arc could damage the plasma welding torch 46. The coolant flow switch breaks up the electrical circuit that actuates the gas tungsten arc welding power source contactor 71 in the gas tungsten arc welding power source 74 (most easily done by the remote foot switch pedal 64). Closure of the gas tungsten arc welding power source contactor 71 can only occur if the coolant flowswitch 62 is actuated, indicating that coolant must be flowing back to the recirculator reservoir from the plasma welding torch 46. Therefore, if the volume of coolant delivered to the plasma welding torch 46 is low (for example, if there is no coolant or an insufficient amount of coolant to provide adequate flow), the plasma welding torch 46 will be protected. The coolant flowswitch 62 can be selected to actuate at different flow rates (typically 0.25, 0.5, 1.0, etc. gallons per minute). Therefore, the optimal actuation set point can be chosen to match the minimum coolant flowrate required by the plasma welding torch 46.

As shown in FIG. 13, the coolant flowswitch 62 is adapted to connect to a coolant return hose and recirculator and is part of an existing liquid cooled gas tungsten arc welding system. A standard commercially available plastic or metal flowswitch 124 may be encapsulated in, for example, a protective hard rubber molding 126 to provide robustness. If encapsulated, the flowswitch 124 could be left connected to the torch umbilical when it is disconnected from the gas tungsten arc welding system or include a permanent fitting 128 that is attached to the coolant return hose 84 for attachment to the plasma welding torch 46. Alternately, the coolant return hose 84 could be attached to the permanent fitting 128 and then overmolded by extending the molding to prevent loss or removal of the switch from the coolant return holes 84. The coolant flowswitch 62 also includes a fitting 130 to attach to a return side of to the coolant recirculator 90.

The pair of wires 66 exiting the flowswitch 124 may feature a two pin type connector that mates in series with a power source contactor switch 63 pre-wired to the remote foot switch pedal 64 and the gas tungsten arc welding power source contactor 71. Alternatively, a two pin socket could be molded into the rubber molding 126 of the coolant flowswitch 124, and a connector from the remote foot switch pedal 64 plugs into this for the same purpose. The flowswitch 124 could be wired in series with any other design of welding arc contactor system in a similar way to that of a remote foot switch pedal 64.

When coolant is flowing through the plasma welding torch 46 and returning to the coolant reservoir through the coolant flowswitch 124, the coolant flowswitch 124 will be activated, allowing a control signal commanding the gas tungsten arc welding power source contactor 71 to function when an operator presses the remote foot switch pedal 64. If insufficient coolant is flowing due to a blockage in the plasma torch hoses, or if the amount of coolant is inadequate in the reservoir to permit the coolant flowswitch 124 to operate, or if the coolant pump is not activated, then the gas tungsten arc welding power source contactor 71 will not function despite the operator closing the remote foot switch pedal 64. The gas tungsten arc welding power source contactor 71 in the gas tungsten arc welding power source 74 can only be activated if both the coolant flowswitch 124 and the remote foot switch pedal 64 are activated, preventing welding power from being supplied to the plasma welding torch 46 unless sufficient coolant is flowing through the plasma welding torch 46. This protects the plasma welding torch 46 from accidental damage, which could occur if welding power was supplied and inadequate coolant flow existed.

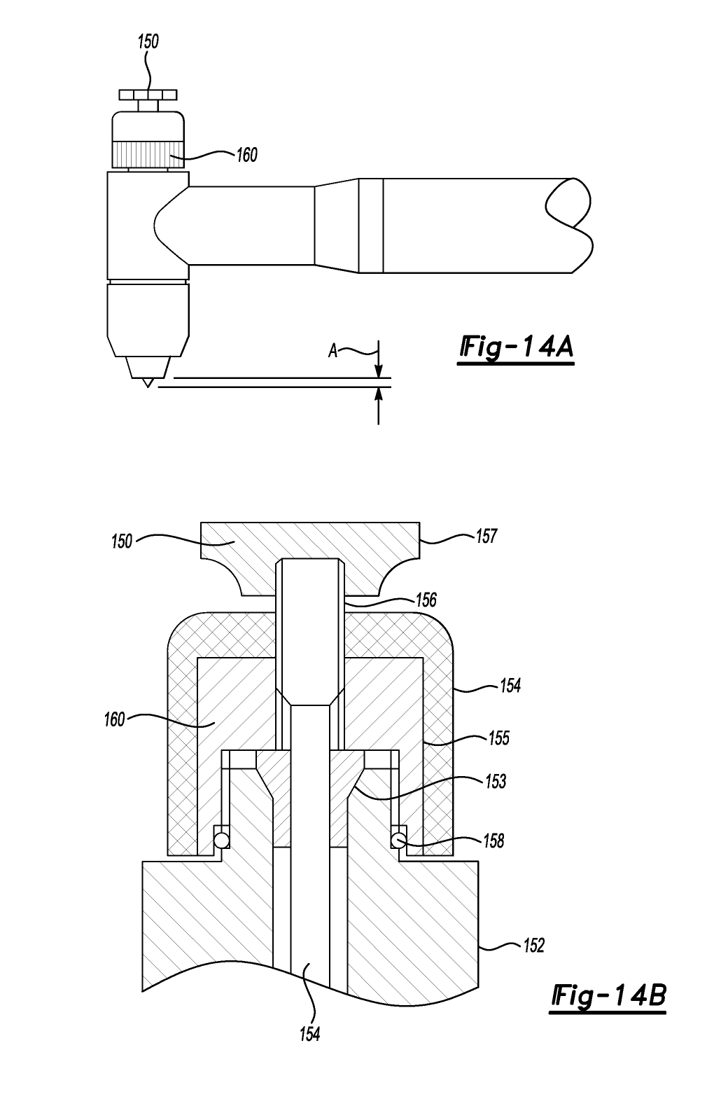

FIGS. 14A and 14B illustrate a feature to adjust the position of the electrode 54 relative to the constricting nozzle 52 to create different arc characteristics with the plasma welding process. The plasma welding torch 46 includes an insulated electrode adjustment screw 150 (including an electrode adjustment screw 156 and an insulative knob 157) and an electrode clamping knob 160 (including an insulative overmolding 154 and a metal insert for a clamping collet 155).

To set the position of the electrode 54, the operator retracts the electrode adjustment screw 150 to push the electrode 54 backwards in an electrode clamping collet 153 (which is only very lightly clamped by the electrode clamping knob 160) until it is flush with a front of the nozzle 52. This is done by allowing a slightly loosened electrode 54 to project from the nozzle 52, resting its point against a flat surface (such as the welding table), and then pushing the plasma welding torch 46 downwards until the front of the nozzle 52 touches the same surface. The electrode clamping knob 160 is then tightened to secure the electrode 54. This creates the electrode 54 to nozzle 52 relationship known as the “flush condition.” The electrode clamping collet 153 is received in an electrode holding body 152. A seal 158, such as an o-ring, is located between the electrode holding body 152 and the metal insert for a clamping collet 155.

Next, the electrode adjustment screw 150 is threaded inwards until it just touches the back end of the electrode 54. If welding occurs with the plasma welding torch 46 in the flush condition, no additional adjustment is needed. If it is desired to work with the electrode 54 in a retracted position, the electrode adjustment screw 150 is then retracted one turn (or a known division or multiplication of this). The electrode clamping knob 160 is loosened slightly and the torch tipped backwards, allowing the electrode 54 to fall back against the electrode adjustment screw 150. While in this position, the electrode clamping knob 160 is re-tightened to secure the electrode 54 in the “set back” condition. Conversely, with the electrode 54 in the flush condition, the electrode adjustment screw 150 could be screwed forward, pushing the electrode 54 outwards from the nozzle 52, whereupon it would have been reclamped by the electrode clamping knob 160 to secure the electrode 54 in the “set forward” condition (shown in FIG. 14A as an offset A).

In one example, a screw pitch of 1.5 mm can be employed for the electrode adjustment screw 150, and one full turn in either direction advances or retracts the electrode 54 by this amount. However, other pitches of thread could be used to affect larger or smaller adjustments. Additionally, graduations on the electrode adjustment screw 150 could be used to indicate fractions of a turn in the same way as was detailed for the plasma gas flow control valve 110 described earlier.

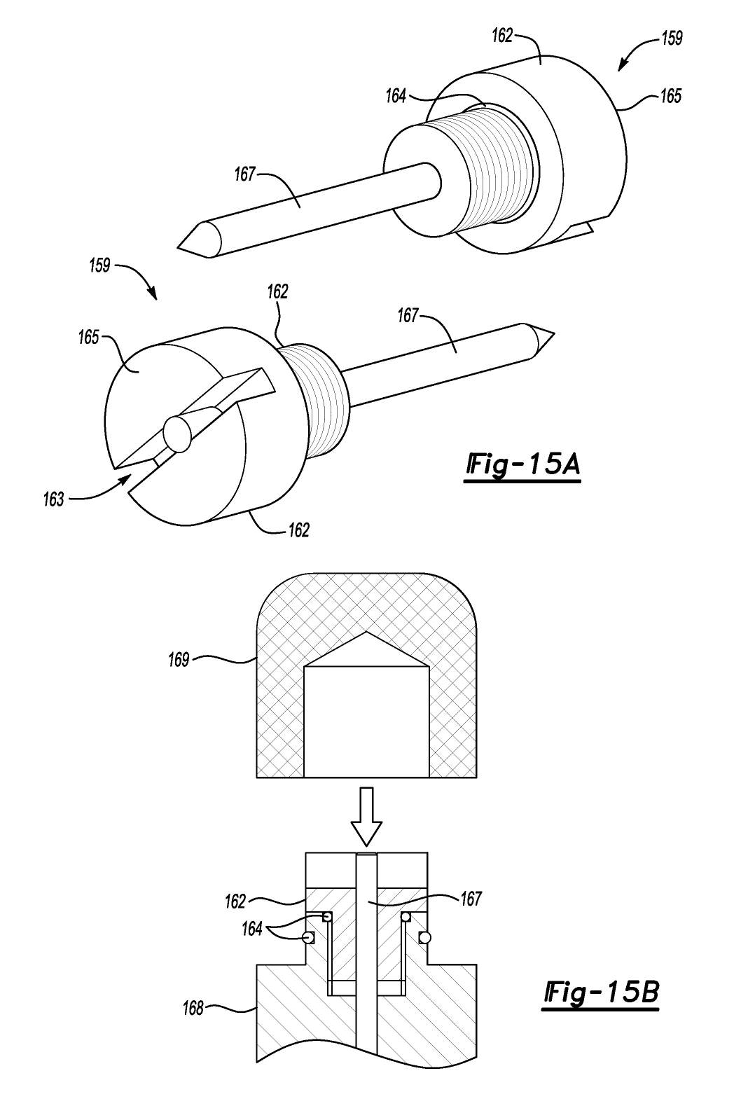

FIG. 15A illustrates a unitary electrode 159. If the plasma welding torch 46 is not easily accessed or moved for the purposes of setting the electrode position accurately as described, the electrode 54, the electrode clamping collet 153 and the electrode clamping knob 160, etc. can be replaced with the unitary electrode 159 that combines these features. A tungsten electrode 167 is press fitted or soldered into a threaded copper body 162, which may be screwed into a torch body 168. An o-ring 164 under a head 165 creates a gas tight seal, preventing leakage of the plasma gas from the rear of the plasma welding torch 46. The unitary electrodes 159 would be supplied to precisely pre-machined lengths so that the nozzle/electrode set-back relationship is consistently maintained when the parts are replaced due to normal wear. As shown in FIG. 15B, for manually operated welding torches, an insulated push-on back cap 169 would prevent the operator from accidentally touching the back of the unitary electrode 159 or the torch body 168 to the workpiece 88 (creating an electrical short in) in use. The head 165 also includes a screwdriver slot 163, for the purposes of fitting or removal of the unitary electrode 159.

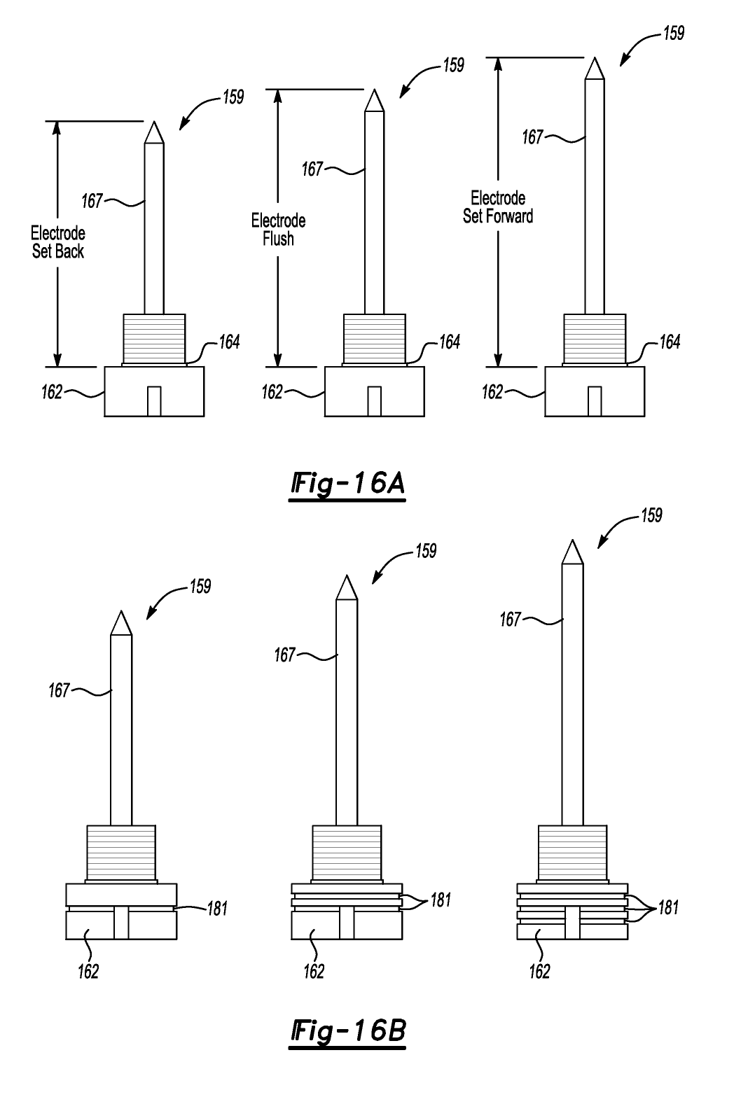

FIG. 16A and FIG. 16B show unitary electrodes 159 in the “set back,” “flush,” and “set forward” conditions, respectively, and how they could be clearly differentiated to ensure use of the correct part. In one embodiment, a colored paint mark could be applied to the head 165 of the threaded copper body 162. In another embodiment, the color of the o-ring 164 indicates the position of the electrode 167. For example, a “set back” unitary electrode 159 could have a blue o-ring 164, a “flush” unitary electrode 159 could have a red o-ring 164, and a “set forward” unitary electrode 159 could have a black o-ring 164. Alternately, as shown in FIG. 16B, the unitary electrodes 159 are identified by a number of machined grooves 181 in the head 165 of the unitary electrode 159. For example, a single groove 181 could indicate a “set back” unitary electrode 159, two grooves 181 could indicate a “flush” unitary electrode 159, and three grooves 181 could indicate a “set forward” unitary electrode 159. In another example, a letter could identify the type of unitary electrode 159.

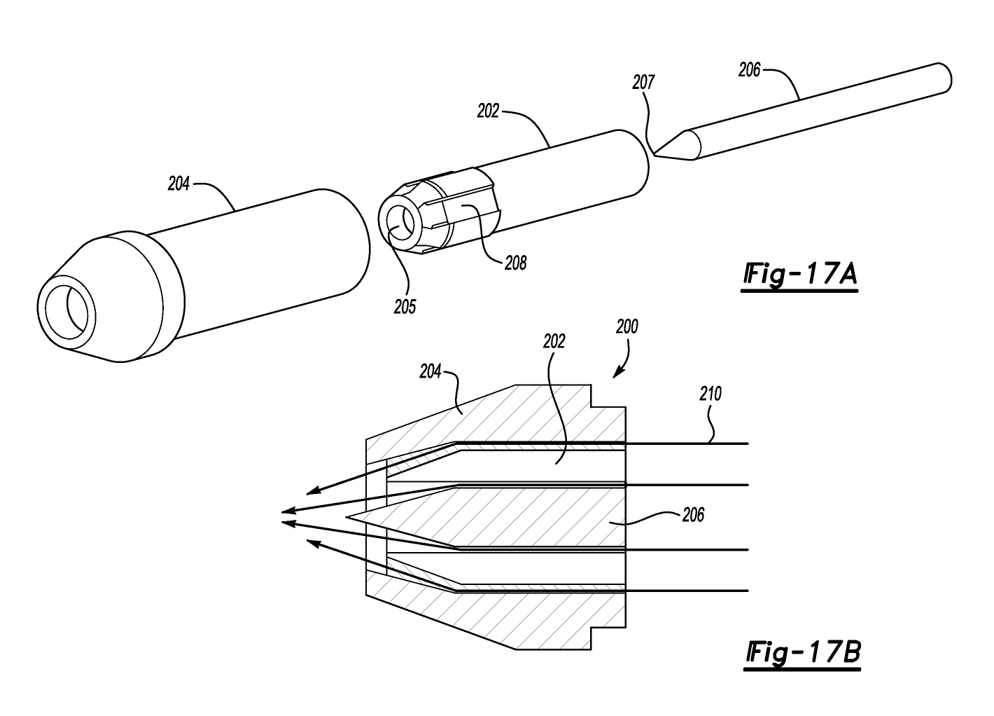

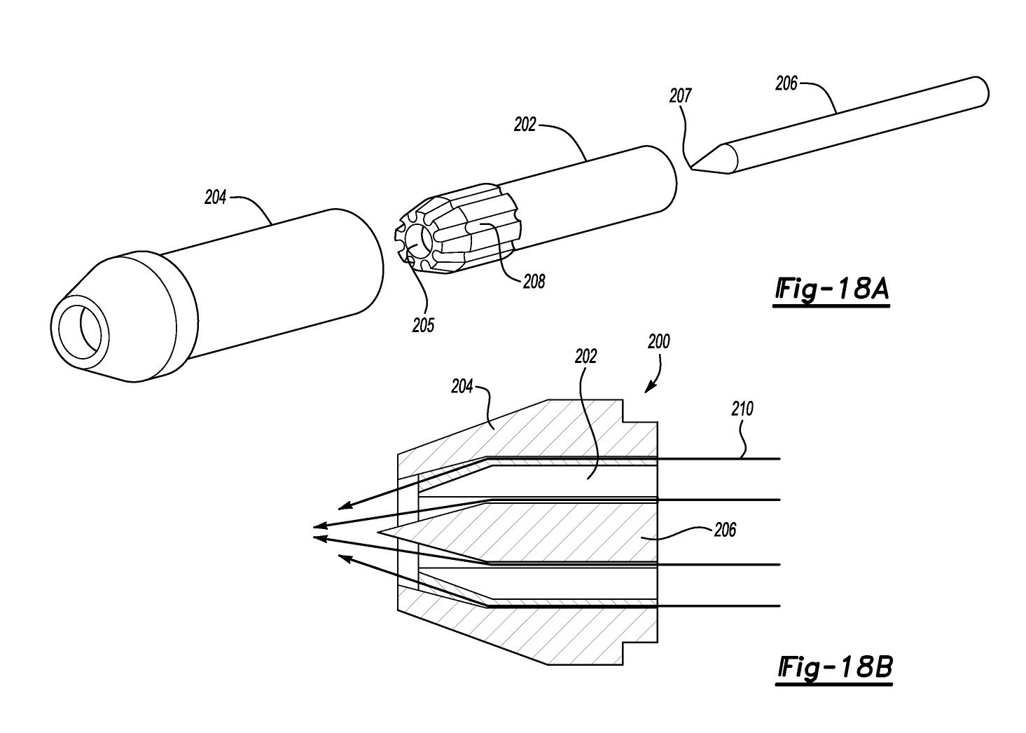

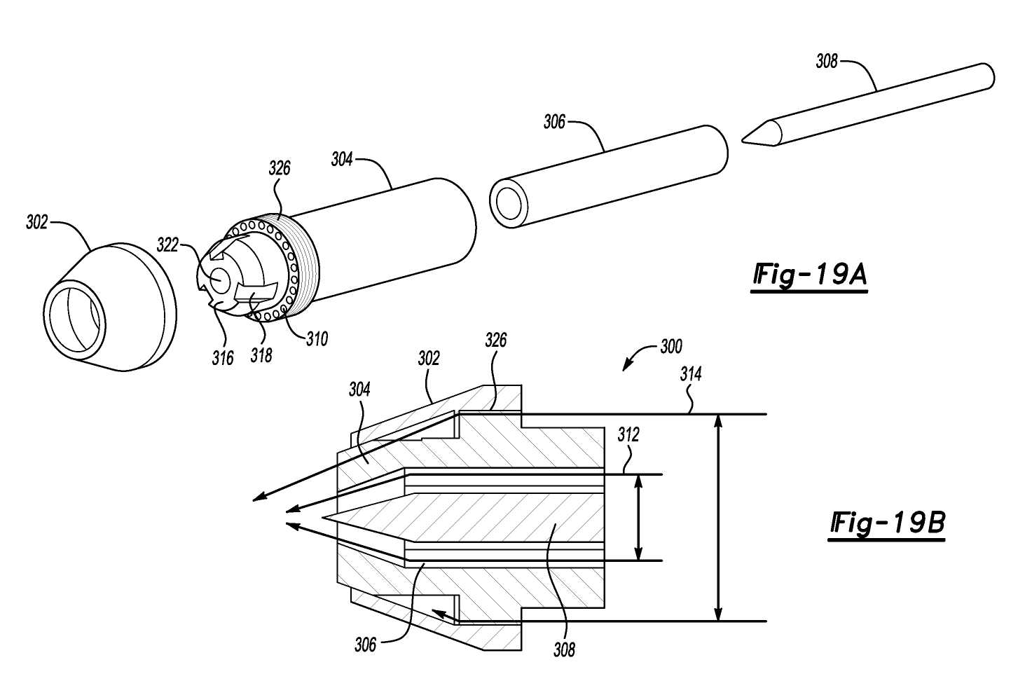

A plasma torch nozzle having a multiport design can provide improved weld penetration, process efficiency and welding travel speed. FIGS. 17A, 17B, 18A and 18B illustrate a plasma torch nozzle 200 including a ceramic insulator 202 placed inside a torch body 204 to electrically insulate an electrode 206 from the plasma torch nozzle 200 except near the point 207 of the electrode 206 where it is desired for a commonly used pilot arc to be operated. The ceramic insulator 202 includes focusing ports or grooves 208 on an external surface that focus a constricting and plasma gas 210 that flows centrally to the welding arc. Two or more ports are effective in focusing the welding arc, but between 6 and 12 ports create a more uniform shape of the welding arc. In one example, shown in FIGS. 17A and 17B, there are 4 focusing ports or grooves 208 each having a square or rectangular shape. In one example shown in FIGS. 18A and 18B, there are 8 ports or grooves 208 having a curved or radius shape. In one example, at least 6 ports are employed. The larger the number and the size (or cross sectional area) of the focusing slots or grooves 208, the more the supply of the plasma gas 210 will bleed off through the focusing slots or grooves 208 rather than travel through a central orifice 205.

The ceramic insulator 202 can be made of any material, but in one example the ceramic insulator 202 is made of a soft and easily machined ceramic called boron nitride. By machining ports or grooves 208 onto the ceramic insulator 202, the welding arc can be focused without drilling focusing holes in the plasma torch nozzle 200. The life of the ceramic insulator 202 can be many times longer than the plasma torch nozzle 200, reducing costs as ceramic is easy to manufacture. The number and shape of the ports or grooves 208 may be chosen to optimize the focusing for any given application.

FIGS. 19A and 19B illustrate another plasma torch nozzle arrangement 300. The plasma torch nozzle arrangement 300 includes a shield cup 302, a torch body 304, an insulator 306 and an electrode 308. The plasma torch nozzle arrangement 300 includes focusing holes or grooves 310 in an annular ring 326 around the periphery of the nozzle that do not bleed off plasma gas 312 to focus the welding arc. Instead, a shielding/constricting gas 314 that is commonly used in plasma welding is redirected as a focusing gas through the focusing holes or grooves 310.

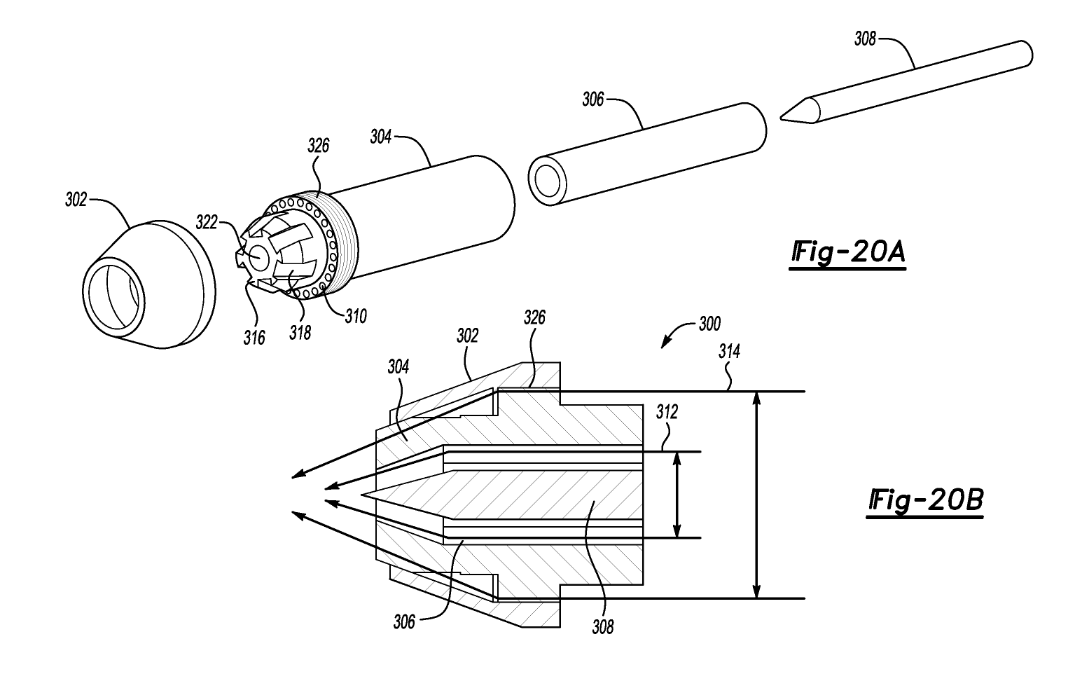

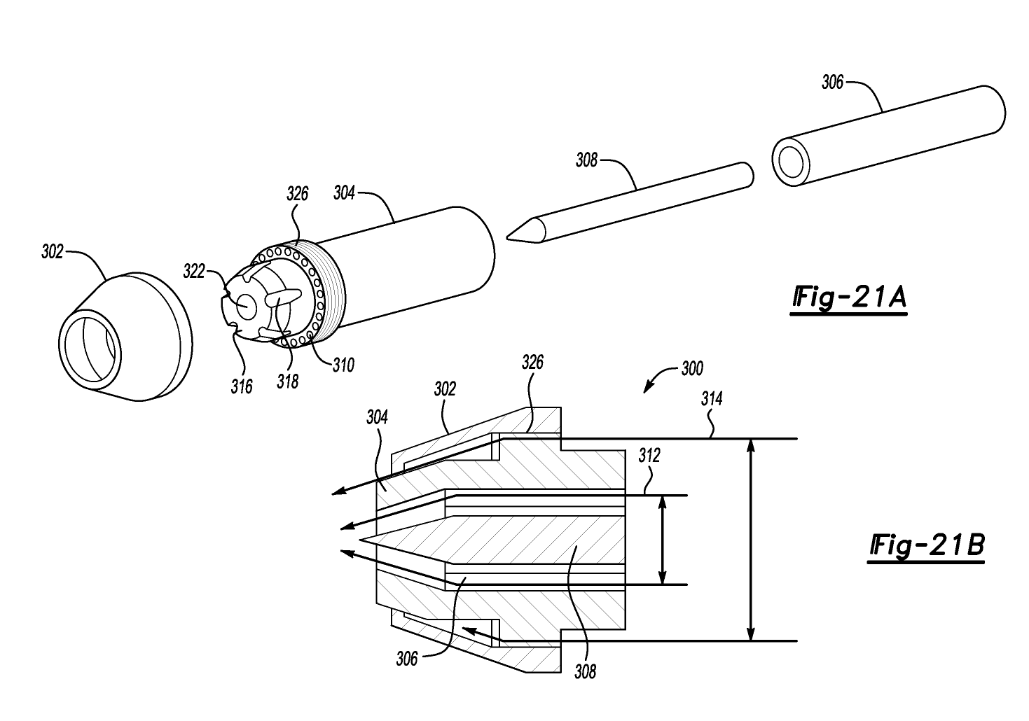

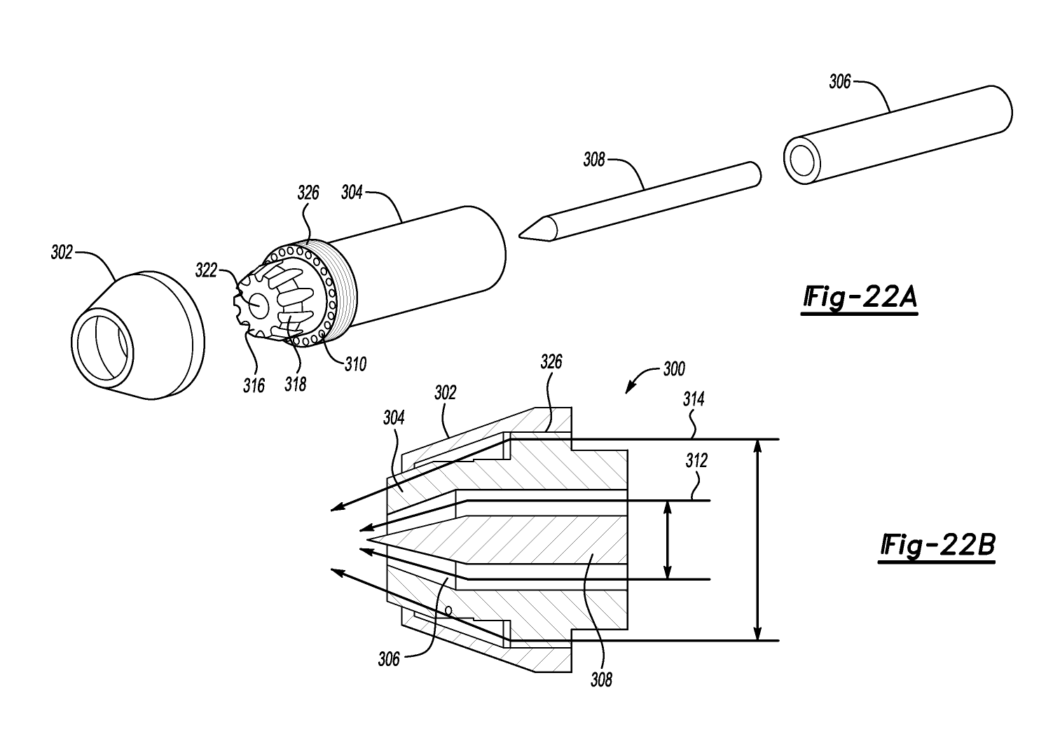

The nozzle 316 located in the torch body 304 includes grooves or slots 318 disposed around a periphery of the nozzle 316 to direct the shielding gas as a focusing medium. In FIGS. 19A and 19B, the nozzle 316 includes 3 square or rectangular grooves or slots 318. Designs showing 6 square or rectangular grooves or slots 318, 5 curved or radiused grooves or slots 318, and 10 curved or radiused grooves or slots 318 are shown in FIGS. 20A to 20B, FIGS. 21A to 21B and FIGS. 22A to 22B, respectively. However, the nozzle 316 can include any number or shape of grooves or slots 318.

The shield cup 302 seals against both the chamber of the supply of shielding/constricting gas 314 and the outside of the torch body 304 so that the shielding/constricting gas 314 can only escape through the focusing holes or grooves 310, and the composition of the shielding/constricting gas 314 and its metering can be determined.

In FIGS. 19A, 19B, 20A, 20B, 21A, 21B, 22A and 22B, the shielding/constricting gas 314 can be separately metered from the plasma gas 312, and their ratios can be varied in a precisely controlled and repeatable manner. Additionally, the pressure of the supplied shielding/constricting gas 314 can be higher than that of the plasma gas 312, causing the welding arc emerging from the central orifice 322 to be further squeezed or compressed, providing additional focusing. Additionally, the shielding/constricting gas 314 and the plasma gas 312 can have the same or different compositions.

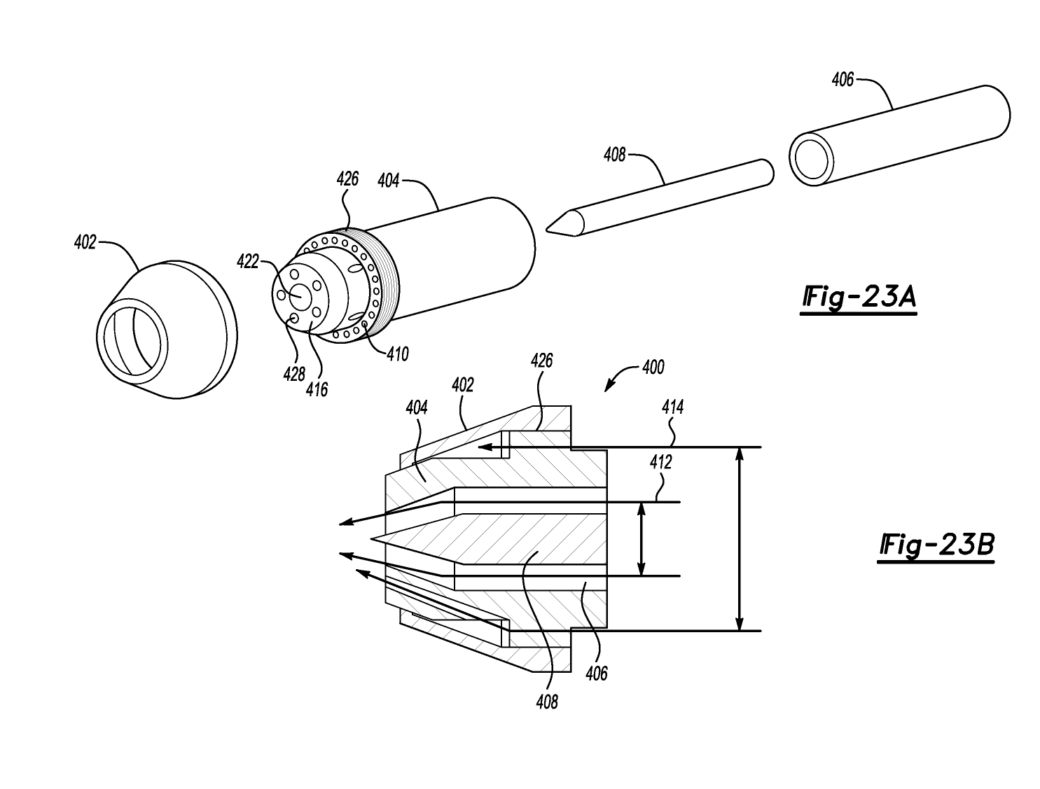

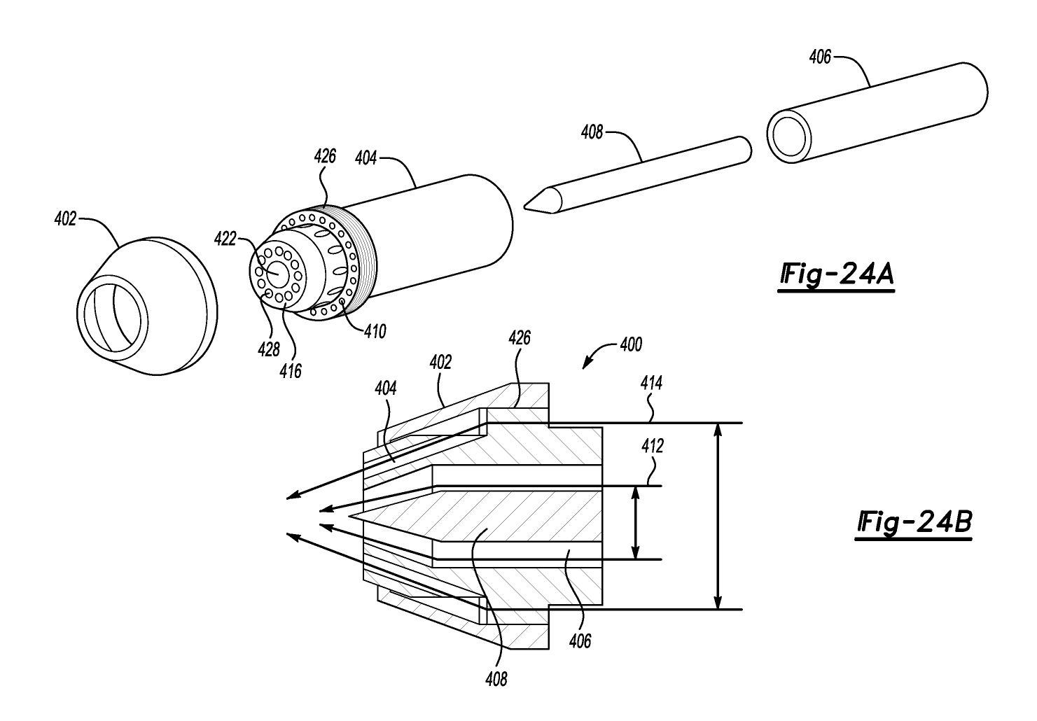

FIGS. 23A, 23B, 24A and 24B illustrates another embodiment of a plasma gas nozzle arrangement 400 including a plurality of holes 416 on a surface of the nozzle 404 that surrounds a central bore 422. The numbers in this example have the same numbers as the previous example, except the numbers are increased by 100. The plurality of holes 416 surround the central bore 422 (through which the plasma gas flows) of the nozzle 404 and the shield gas flows through the plurality of holes 416 to focus the welding arc. In one example, the plurality of holes 416 are drilled into the nozzle 404. In this example, the shielding/constricting gas 414 is supplied to the welding arc though the plurality of holes 4 instead of the grooves or slots 318 of FIGS. 19A to 22B.

In the above examples, any number, size or shape of holes, slots or grooves in the nozzles can be employed. Additionally, any gas flow rates, pressures or compositions can be used.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A welding system comprising:
a gas tungsten arc welding power source including a welding arc contactor;
a plasma welding torch;
a gas console that supplies gases to the plasma welding torch;
a coolant flow switch connected in series with the welding arc contactor, wherein power is not provided from the gas tungsten arc welding power source to the plasma welding torch when the coolant flow switch is not actuated.

2. The welding system as recited in claim 1 wherein the gas console includes a plasma gas flowmeter and a shield gas flowmeter.

3. The welding system as recited in claim 1 wherein a gas tungsten arc welding power source contactor of the gas console functions when a remote foot switch pedal is actuated.

4. The welding system as recited in claim 1 wherein a supply gas is fed into the gas tungsten arc welding power source, and the supply gas is supplied from the gas tungsten arc welding power source to the gas console.

5. The welding system as recited in claim 1 including a flow control valve that proportions plasma gas through the plasma welding torch, wherein shield gas flows through the plasma welding torch, and a flow of the plasma gas can be adjusted independently of a flow of the shield gas.

6. The welding system as recited in claim 1 wherein a flow control valve includes a tee-piece that divides a gas supply into a plasma gas flow branch through which plasma gas flows and a shield gas flow branch through which shield gas flows, the flow control valve proportions the plasma gas through the plasma welding torch, the shield gas flows through the plasma welding torch, and a flow of the plasma gas can be adjusted independently of a flow of the shield gas.

7. The welding system as recited in claim 1 wherein a plasma welding torch includes a plasma gas diversion/flow control feature.

8. The welding system as recited in claim 1 wherein the coolant flowswitch provides a safeguard feature to the plasma welding torch.

9. The welding system as recited in claim 1 including a unitary electrode having an electrode attached to a body that is fitted into the plasma welding torch in a guaranteed position.

10. The welding system as recited in claim 9 wherein the unitary electrode is pre-assembled a nozzle/electrode set-back relationship is consistently maintained during replacement of the unitary electrode.

11. The welding system as recited in claim 9 wherein the unitary electrode includes a visual indicator that indicates a length of the electrode.

12. A plasma torch nozzle arrangement comprising:
a torch body;
an insulator located inside the torch body, wherein the insulator includes focusing ports or grooves on an external surface of the insulator that focus a shielding gas centrally towards a welding arc; and
an electrode.

13. The plasma torch nozzle arrangement as recited in claim 12 wherein the focusing ports or grooves are square, rectangular or include a curved surface.

14. The plasma torch nozzle arrangement as recited in claim 12 wherein the insulator is made of boron nitride.

15. A plasma torch nozzle arrangement comprising:
a shield cup to prevent leakage of a shielding gas;
a torch body;
an annular ring including focusing holes that focus the shielding gas centrally towards a welding arc;
an insulator located inside the torch body; and
an electrode.

16. The plasma torch nozzle arrangement as recited in claim 15 further including a nozzle, and the nozzle includes grooves or slots to direct the shielding gas as a focusing medium.

17. The plasma torch nozzle arrangement as recited in claim 16 wherein the grooves or slots are square, rectangular or include a curved surface.

18. A plasma torch nozzle arrangement comprising:
a shield cup to prevent leakage of a shielding gas;
a torch body;
a nozzle including a surface having a central bore and shield gas holes surrounding the central bore through which a shielding gas flows that is focused centrally towards a welding arc;
an insulator located inside the torch body; and
an electrode.
